(19) United States
(12) Patent Application Publication
(10) Pub. No.: US 2009/0055639 A1
(43) Pub. Date: Feb. 26, 2009

(54) Methods and system for modular device booting

(76) Inventors: Kimmo Kuusilinna, Tampere (FI); Jari Nikara, Tampere (FI); Vesa Lahtinen, Kangasala (FI); Antti Latva-Aho, Kangasala (FI)

Correspondence Address: Hollingsworth & Funk, LLC, 8009 34th Avenue South, Suite 125, Minneapolis, MN, 54425, US

(21) Appl. No.: 11/894,122

(22) Filed: Aug. 20, 2007

(51) Int. Cl. G06F 9/00

(52) U.S. Cl. 713/2

(57) ABSTRACT

The present invention a method for modular device booting comprising retrieving a first boot code from a non-volatile memory element, receiving a memory access request from at least one subsystem, said memory access including at least a boot status indication indicating a memory region and a memory address, if said received address and region match a predefined address and region, associating said at least one subsystem with a corresponding subsystem boot code address included in said retrieved first boot code, retrieving a corresponding subsystem boot code from said associated boot code address, and transferring said boot code to said corresponding subsystem.

### FIELD OF THE INVENTION

The present invention is related to modular devices, and in particular to boot mechanisms in modular devices.

### BACKGROUND ART

A modular device setup allows to design extendable and flexible device structures. Typically, a terminal such as a mobile communication terminal comprises several components which all have their dedicated tasks related to the communication and application services provided to the user of the terminal. These components are frequently designed separately from each other, e.g. based on the respective functionality or on processing considerations. In a modular design, a memory architecture has to be chosen thoughtfully. One or more memory elements (volatile or non-volatile) may be provided for all underlying components, or in other cases each component may have separate memory elements.

Often, memory elements have to be chosen in accordance with specific operation requirements for a certain function, e.g. fast read access or low power consumption. It may therefore be necessary to have more than one type of memory element within a device. Sharing a larger memory element between several subsystems may contribute to an economic design, as long as the modular character is logically maintained by an appropriate memory management scheme.

In modular devices, four different memory setups may typically be considered. In a first one, a local physical memory element may be present in each separate module, and access from outside the module to each memory element may be restricted. This corresponds to a truly modular setup on both hardware and logical level, but involves e.g. higher costs due to a larger number of hardware elements. In another potential setup, each module may again have a separate local memory element, but memory access from outside may be allowed. This means modules are interdependent, and services operating across module boundaries may be designed very efficiently with regard to memory usage. However, memory coherency may raise serious difficulties. It is also possible to provide a global physical memory element for several modules, which allows two more potential setups.

For one thing, the global memory may be physically shared, but access may be limited on a logical basis. Each specific module may be allowed to access certain defined memory regions, and a memory management unit may be provided for controlling module access to memory. In this way, a low cost architecture may be achieved with a clean programming model. It is also conceivable to have unrestricted memory access for a global memory element. This option may correspond to a traditional multi-level cache arrangement, which is costly and has high power requirements. Yet, a design with global memory and unrestricted access would violate the modular design principle in every way.

In a modular system or design architecture, boot-up procedures may not be trivial. It may be desired that modules or subsystems of such a system are as independent as possible, which would imply that each of the modules has at least its own processor, and also a local physical memory which contains at least its boot loader, i.e. code for initiating the operating functionality of each module. Again, a single memory element for all subsystems would be much more cost-effective than separate memory elements for each of the subsystems. Yet, the boot procedure of each single module still has to be coordinated with the booting of the complete device or system.

In some way, the processor of each subsystem needs to receive instructions for booting when the device is powered up. As the volatile subsystem memory is preferably empty at start-up and an external memory may also require a boot procedure itself for functionality, a network boot may not be possible. A boot mechanism for modular devices may also be required for optimal interoperability of separate components, e.g. from different vendors, in order to exploit all advantages given by modular design.

### SUMMARY

Thus, according to a first aspect of the invention, a method is provided comprising in exemplary embodiments retrieving a first boot code from a non-volatile memory element, and receiving a memory access request from at least one subsystem, where the memory access includes at least a boot status indication indicating a memory region and a memory address. If the received address and region match a predefined address and region, then the at least one subsystem is associated with a corresponding subsystem boot code addresses included in the retrieved first boot code. A corresponding subsystem boot code is retrieved from said associated boot code address, and the boot code is transferred to the corresponding subsystem.

In some embodiments, the method may further comprise determining a data port the memory access request has been received on, and associating said determined data port with a subsystem boot code address based on information included in said first boot code.

Furthermore, the method may comprise extracting said information related to associations of data ports and subsystems and to subsystem boot code addresses from said first boot code.

Exemplary embodiments include allocating stacks for said boot codes at a volatile memory element.

In some embodiments, said method may be performed by a global memory management unit connected to said at least one subsystem and said memory elements. Optionally, said connection is achieved by a point-to-point network.

According to exemplary embodiments several memory access requests are received, and the method may further comprise handling said requests in a predefined order.

Furthermore, said subsystem boot code may include information for booting a network coupled to said subsystem. As an example, said information may include at least one media access control MAC address.

In further embodiments the method may comprise storing an indication of said completed boot code transfer after transferring said subsystem boot code. Such an indication may e.g. be a bit flag, or may be stored in a parameter table and associated with a corresponding subsystem identifier. If said indication corresponds to a completed boot code transfer, the method may further comprise preventing any further access to said boot code address.

According to some embodiments, the method may also comprise restricting any write accesses to said boot code addresses.

Further, any read accesses to a specific subsystem boot code address for all subsystems not associated with said specific subsystem boot code may be restricted in some embodiments.

Typically, said method is performed on power-up of a modular system.

According to another aspect of the invention, a method is provided comprising issuing a memory access request using a predefined address value and a boot status indication; receiving a boot code in response to said request; and performing a boot procedure based on said boot code.

The issuing may further comprise issuing said memory access request with said predefined address value to a local memory manager; and adding said predefined boot status indication to said request at said local memory manager.

In further embodiments, the method may include setting a processor register to a reset value. As an example, said issuing of said memory access request may be triggered by said register reset value.

According to some embodiments of the invention, the method may comprise decrypting said received boot code. In some embodiments this may comprise utilizing decryption code included in an unencrypted part of said received boot code. Further embodiments may then utilize a decryption key stored in a local non-volatile memory element. As another option, the method may comprise utilizing decryption code stored in a local non-volatile memory element.

In exemplary embodiments, the method may further comprise booting an external network, and transmitting said memory access request via said booted network. In this case, the method may for example be performed by a subsystem including at least a processor and a non-volatile memory element, wherein boot code for said external network is stored on said non-volatile memory element.

In general exemplary embodiments, the above steps may be performed by a subsystem including at least a processor, wherein said subsystem is connected to an external global memory manager.

According to another aspect of the invention, a computer program product is provided comprising computer code which, when executed on a processor or microcontroller, will execute any of the above method steps.

According to another aspect of the invention, a system is provided comprising at least one subsystem including a processing unit and a local memory management unit; a global memory management unit connected to said at least one subsystem; a non-volatile memory element connected to said global memory management unit; wherein boot codes for said global memory manager and said at least one subsystem are stored in said non-volatile memory element, and wherein said boot codes are located at predefined memory addresses.

A system may in some embodiments further comprise a volatile memory element connected to said global memory management unit.

In exemplary embodiments, wherein said boot code for said global memory manager includes at least information on the predefined memory addresses for said at least one subsystem boot code.

As an example, said global memory management unit may be connected via a data interconnect, which may e.g. be a point-to-point connection.

The subsystems may in some embodiments be connected to each other via a control interconnect, which may e.g. be a network having routing capabilities.

According to a further aspect of the invention, a system may be provided comprising: means for retrieving a first boot code from a non-volatile storage means; means for receiving a memory access request from at least one subsystem, said memory access including at least a boot status indication indicating a memory region and a memory address; means for deciding whether said received address and region match a predefined address and region; means for associating said at least one subsystem with a corresponding subsystem boot code addresses included in said retrieved first boot code; means for retrieving a corresponding subsystem boot code from said associated boot code address; and means for transferring said boot code to said corresponding subsystem.

The above summary is not intended to cover each and every detail or embodiment of the invention, and these are to be understood as exemplary embodiments only. Some details and potential enhancements will be apparent to the person skilled in the art from the below description of example embodiments.

### BRIEF DESCRIPTION OF APPENDED FIGURES

In the following, exemplary embodiments of the invention will be described in more detail with reference to the appended figures, in which

FIG. 1 is an example hardware organization structure of a mobile terminal;

FIG. 2 depicts a subsystem or component that may be included in a device;

FIG. 3 is an exemplary system arrangement that may allow a modular component booting;

FIG. 4 shows the physical organization of an exemplary memory architecture according to the invention;

FIG. 5 is a schematic communication diagram between several components of an exemplary inventive system; and

FIG. 6 is a flow diagram of exemplary method steps.

### DETAILED DESCRIPTION OF EXEMPLARY EMBODIMENTS

An electronic device such as a mobile communication terminal or a palmtop computer may comprise several separate hardware modules or components. These components may have similar or different functions. A system such as a modular device may be examined on a hardware basis on one side and on a logical basis on the other side. Logically, a system may be composed of a variety of applications and services. These may include communication services, multimedia, user input, and many more.

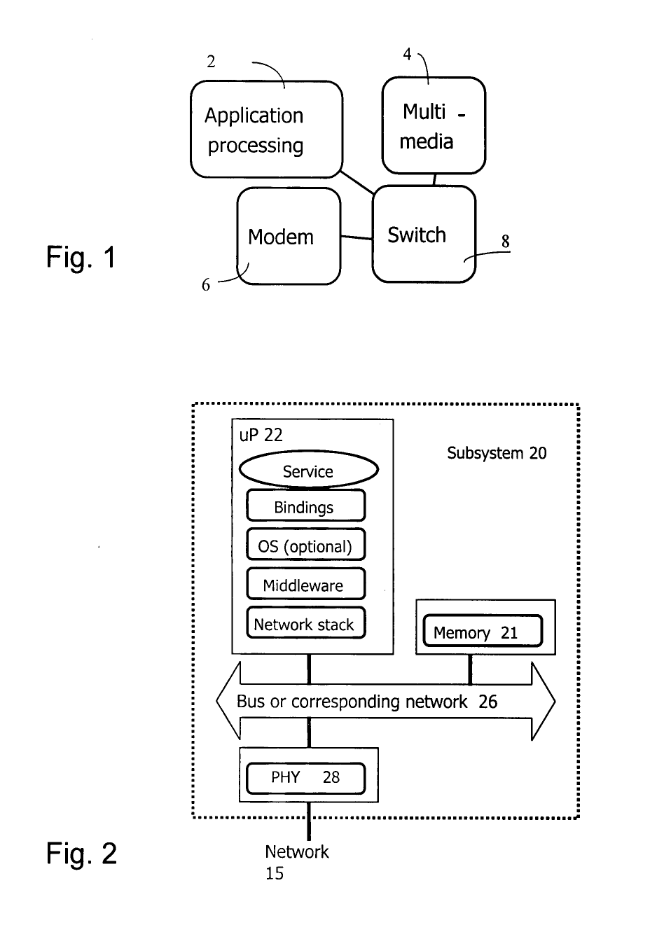

Services and applications may reside on top of any arbitrary hardware architecture, which may be considered as several hardware components or subsystems connected by a communication network for exchanging data and control signals between components. For a complete system view, applications and services may be mapped onto the components. FIG. 1 depicts an exemplary high-level hardware organization structure of a mobile device. One component or subsystem 2 may be used for application processing and may for example comprise one or more memory elements and a processing unit such as a microprocessor. Another component 4 may be directed to multimedia contents, such as output of video and audio data to a user.

A third component may be a modem 6 or another communication unit for communication with an external network, e.g. a local area network LAN or a radio communication unit for interfacing with a telephone network. The switching unit 8 connected to all of these components may allow to transfer signals and data between components. Further or other components not shown here may be included in a system or connected to a system. Some or all of the components may be included in a single device, or they may be provided with interfaces for connecting modules together. For example, a mobile terminal may be provided with a multimedia unit, a user input unit and a communication unit. Modular setups may be designed in a way as independent as possible. For this reason, some modules or subsystems may each have its own dedicated memory element for data storage.

Modules or subsystems may also be integrated within a single chip package in horizontal or three-dimensional configuration. For example, there may be a chip package including at least one logic die as a subsystem and at least one memory die stacked on top of the logic die. Also, several dies may be stacked on top of each other and may for example be connected by a face-to-face connection. All memory units within the package system may be handled by a single memory manager unit, while the subsystems may communicate with this memory manager and do not have direct access to the complete set of memory elements. With the 3D stacked connection within a single package, small sized packages with reduced board space are possible. Also, several units with different manufacturing technologies and capabilities may be used within one system.

In FIG. 2, a component or subsystem 20 of a modular system is shown. The component may include its own microprocessor or another processing unit 22, and also its own memory element 21 such as a DRAM element or another volatile memory element. Both microprocessor 22 and memory element 21 may be connected by a bus or a corresponding subsystem network 26. On this bus or network 26, a physical connection PHY 28 to a device/system network 15 may be provided.

For purposes of this description, memory structures implementing modular design will be considered. In particular, such structures may on one hand include systems with local physical memory within a module and restricted memory access from outside this module, and also systems having at least one central physical memory element and restricted memory access for subsystems based on logical modularity. The latter type of memory organization will be used for explanatory purposes in this description, although the invention is not at all limited to this structure.

In a modular system having a central memory element for several subsystems, booting of the overall system and each individual subsystem has to be controlled. Subsystem memory should be empty at startup of the system and can therefore not be used for bootstrapping the subsystem. Also, a connecting network may require a boot procedure itself and may not be available for network booting. Booting procedures may be implemented independently such that subsystems may be provided by third parties. Security concerns have to be considered for booting procedures, since any undesired code in subsystem memory may pose a security risk.

According to an embodiment of the invention, intelligent memory management units IMMU, which may be separated into one global unit and several local units embedded in subsystems, may be included in a device to control memory access for at least one central memory element. A global memory management unit GIMMU may allow or prevent memory accesses based on access codes for certain memory regions, so-called region codes. The region codes are communicated to a subsystem or a local memory management unit LIMMU within a subsystem at the time of memory allocation for this subsystem. The subsystem may then employ a local addressing scheme internally, and the IMMU may translate the local addresses into physical memory addresses, using the region code or a similar identifier as an authentication for access. The LIMMU may forward the memory request to the global memory manager GIMMU.

It is to be noted that a LIMMU is not strictly necessary in a subsystem; a single intelligent manager IMMU could provide address translations coming from the subsystems. A LIMMU is necessary in subsystems that need local memory space management. In addition, a LIMMU is desirable to keep the GIMMU complexity manageable.

It is possible to translate local addresses to physical addresses in the GIMMU instead of the LIMMU, i.e. LIMMU does only forward the local address and region code, while the GIMMU maps this information to a physical address. That is, the GIMMU does the actual address translation. The region code is used here just as an example for a boot situation indicator, however, the indication of boot status of a subsystem does not have to be a region code but can also be communicated by other means.

In general, such a structure allows for modular memory design on logical level while providing a shared physical memory element. Generally, the shared memory element may be logically divided into memory regions which may be controlled and allocated or deallocated by the global memory manager. In this way, the subsystem(s) do not need to have direct physical memory access and do not even have to know the actual physical memory structure and addressing scheme. Rather, each subsystem may be informed by the global memory management unit GIMMU of region codes pointing to a certain memory region which is allocated to that subsystem. On subsystem level, memory addressing may thus be completely independent and detached from the actual physical memory structure.

The memory management units may then be responsible for mapping these local memory addresses and structures to the actual physical memory addresses for any memory operations. Memory regions may also e.g. be transferred from one subsystem to another by simply updating the respective associations such as region codes at the global memory management unit, without any change of physical structure or actual moving of memory content. The principle of region codes ensures that a subsystem can only access memory that has been allocated to that subsystem, and the region code for a memory region is used as an access identifier to prevent memory access to restricted memory areas for a specific subsystem.

As an example, a subsystem processor may require read memory access. It will issue a read request to the local memory management unit, including e.g. a memory address using a local addressing scheme. The local memory management unit LIMMU has information from the global memory management unit regarding the associated region code for an allocated memory region, and also regarding address translation. Thus, IMMU may map the local memory address to a physical memory address based on this information and use the correct region code. Subsequently, LIMMU may transfer the read request together with memory address and associated region code to the global memory management unit GIMMU. This global memory management unit GIMMU may then identify the correct region code and allow access. Optionally, the LIMMU may request memory allocation when necessary and may receive the respective region code for the newly allocated memory in return. As will be understood by the person skilled in the art, write procedures and other memory operations may be performed in a similar way via LIMMU and GIMMU using region codes and logical address spaces.

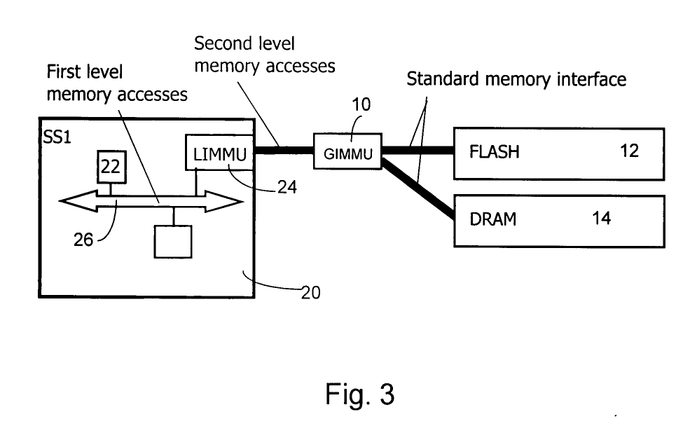

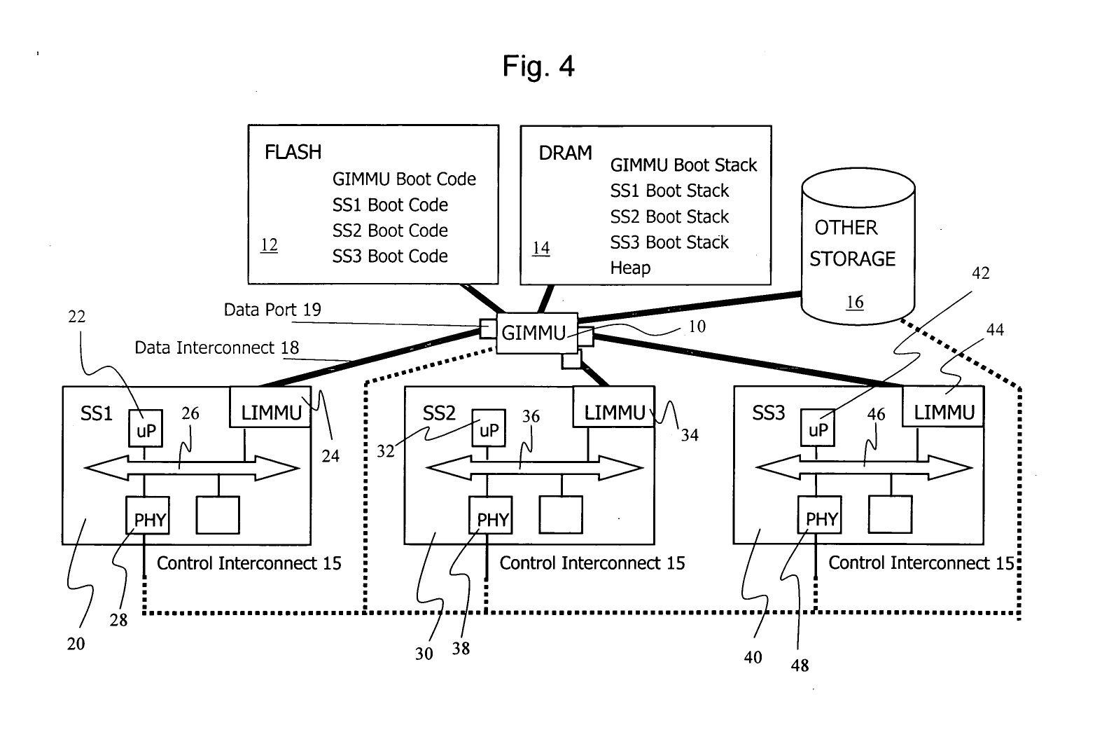

FIG. 3 gives an example of a basic system arrangement allowing modular subsystem booting. A first subsystem SS1 20 is shown, including a microprocessor 22, a local memory management unit LIMMU 24, and a network or bus 26 connecting the elements within the subsystem. Further elements may be included in the subsystem 20, such as a physical connection PHY 28 to a device network 15, a local volatile or non-volatile memory element (not shown), functional components and interfaces, and others. While only a single subsystem is shown in this schematic figure, any number of further subsystems may be present (see also FIG. 4 below), which may optionally also vary in structure and function. A non-volatile memory element 12 such as a flash memory unit may be provided. Furthermore, a volatile memory element 14 such as DRAM may optionally be included in the system. A global memory management unit GIMMU 10 may be provided for connecting the subsystem 20 to the shared memory elements 12, 14.

A connection may be provided in particular between local LIMMU 24 and global GIMMU 10 memory management units. Of course, when more than one subsystem is present, these may also be connected to the global memory management unit GIMMU 10 in the same way for access to shared memory elements. It shall be noted that FIG. 3 is only a simplified schematic illustration, and that other elements and connections between elements may be included in a system according to embodiments of the invention.

In a system arrangement such as that of FIG. 3 or a similar arrangement, two-level memory access procedures may be used. As explained above, memory accesses inside the subsystem or component may use a separate address space from the physical storage address space and may typically resemble “conventional” memory mapped accesses, i.e. at least a command such as a read or write request and a memory address the command is directed to. These subsystem internal memory accesses may be regarded as a first level memory access.

On the second level, memory accesses between subsystems and the global shared memory are only allowed for pre-allocated memory regions which are identified by associated region codes. The global memory management unit GIMMU keeps track of all allocated memory on a global level. This may e.g. be achieved by storing region codes and associated physical memory addresses and subsystems in a parameter table. On a local subsystem level, memory may optionally also be sub-allocated by a local memory management unit, thus allowing to create several logical address subspaces for one or more subsystems.

Based on the region code memory access via a memory management unit, a boot procedure may be implemented according to an embodiment of the invention. One region code may be predetermined for booting purposes and may be the same for all subsystems or components. When this special region code or another boot status indicator is used in a memory access from a LIMMU to the GIMMU, this access request may not be interpreted as a normal access based on the memory address and region code itself. Instead, this predetermined region code may trigger that this access shall be treated based on the origin of this request. Basically, the use of such a predetermined region code, which may e.g. be 0x00 in an exemplary embodiment, may indicate that this is a request for a subsystem boot code. From the origin of the request, the global memory management unit may then determine a specific address in the shared non-volatile memory unit where the required specific boot code for the associated subsystem is located.

For a more detailed explanation of exemplary embodiments of the invention, reference is now made to FIG. 4, illustrating the physical organization of an exemplary memory architecture. A number of separate subsystems SS1 20, SS2 30 and SS3 40 are shown, each provided with a separate processing unit uP 22, 32, 42, an internal bus 26, 36, 46, a physical connection to a terminal network 28, 38, 48, and a local memory management unit LIMMU 24, 34, 44. All elements within a single subsystem, i.e. the microprocessor, the physical interface, the memory manager and other elements may be connected to the internal bus structure. A flash memory element 12 and a DRAM element 14 are arranged as code storage and/or working storage elements for the system. Furthermore, other storage elements 16 for volatile or non-volatile data storage may be provided in the system.

A global memory management unit GIMMU 10 is provided in the example system and may be connected to each subsystem via a data interconnect 18. In this embodiment, it is assumed that two separate interconnects are present, i.e. a data interconnect 18 and a control interconnect 15. The control interconnect 15 is a real network connecting the subsystems, the global memory manager 10, and the further storage elements 16 together. Flash memory 12 and DRAM 14 are not connected to the control interconnect network 15. Each subsystem may be coupled to the control interconnect via the physical interface PHY 28, 38, 48, corresponding to an OSI layer 1 connection. The control interconnect 15 may be available only after network boot, may include routing functionality and interconnect services, and have a complex interface.

An example for such a control interconnect is MIPI/UniPro. Connections from and to the global memory management unit GIMMU 10 may be arranged by a data interconnect 18, which may comprise point-to-point connections. This may imply that bandwidth is always available with high throughput rates, and typically simple interface structures are utilized without any routing functionality. Data interconnects are provided between GIMMU and each subsystem, as well as between GIMMU and each of the memory elements such as a flash memory element 12, a DRAM element 14 and further storage elements 16. Data ports 19 at the global memory management unit for the subsystem interconnections may allow access and identification of subsystems.

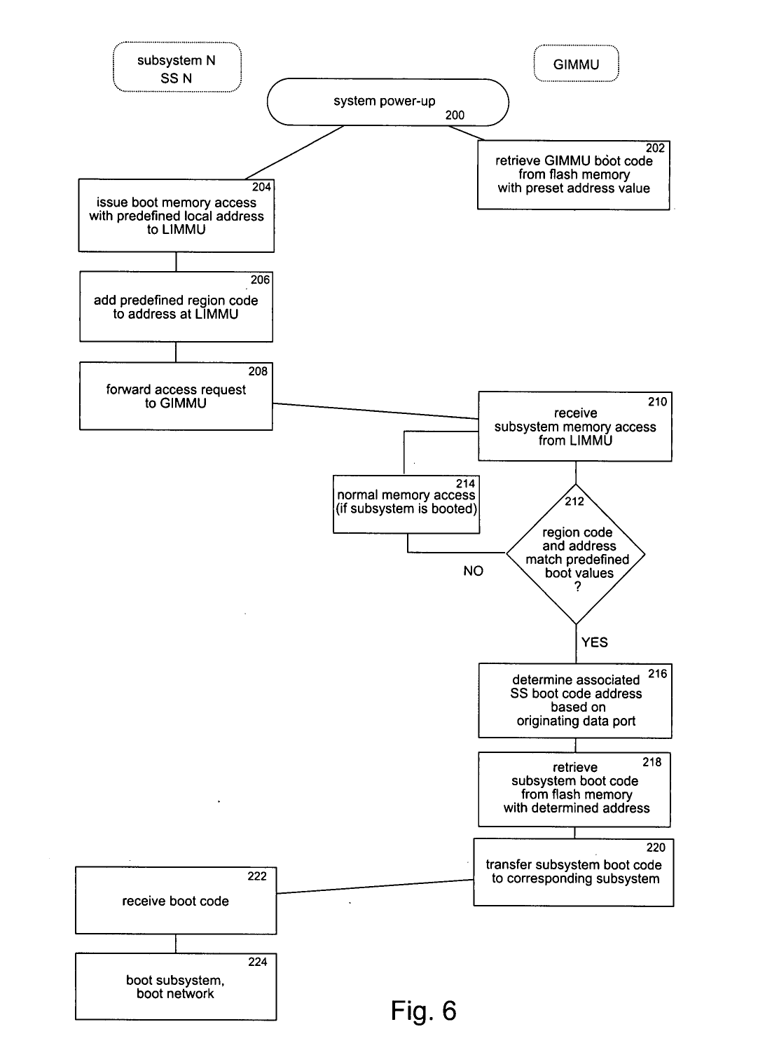

With reference to this physical system structure of FIG. 4, an exemplary booting procedure for such a modular system may be discussed in detail. The respective method steps are also illustrated in the flow diagram of FIG. 6. First, the global memory management unit GIMMU may boot from the flash memory element after power-up of the system (step 200). The GIMMU boot code will be located at a predefined physical address, e.g. 0x00, and GIMMU has direct access to the flash element and may thus request its boot code from flash memory using the predefined memory address in step 202. The GIMMU boot code contains hard-coded addresses for subsystem boot codes in the flash memory, and furthermore hard-coded associations between specific subsystems and data ports.

Subsequently, the GIMMU may allocate fixed amounts of DRAM (or any other working memory) as for the subsystem boot codes and its work memory. The DRAM addressing is also hard-coded, and this information may have been used when creating the boot codes. The amounts are allocated in the GIMMU boot code. At the subsystem processor, a register such as a program counter is set to zero or another suitable reset value, and in response a local memory access with a predefined memory address (such as 0x00) is issued to the LIMMU of the respective subsystem via the subsystem internal bus in step 204. The LIMMU may in steps 206 and 208 then react with a memory access with a predefined memory address (such as 0x00) and an added predefined region code (e.g. also 0x00) from LIMMU to GIMMU.

The system may work as a kind of shadowing memory (as opposed to execute-in-place, XIP). That is, the boot code is copied from FLASH to DRAM and executed from there. Fixing the addressing means that the accesses to the boot code by a subsystem are now directed to the DRAM (not the FLASH). The size of the DRAM allocation may also be a bit larger than the boot code itself to allow some working memory.

The memory access request is transmitted to the global memory manager via the data interconnect and received there in step 210, allowing the GIMMU to identify the data port the memory access originated from. The predefined memory address (such as 0x00) in both the local memory access and the global memory access indicates that this received access request is not to be treated as a normal access, but is to be interpreted based on the data port origin of the access request, which is checked in step 212.

Since the GIMMU has received associations between subsystems and data ports as well as subsystem boot code addresses within the GIMMU boot code in step 202, this allows the global memory manager to translate this special memory access together with the data port identifier into the actual memory address for the boot code of the respective subsystem in the flash element in step 216. After having executed the memory access with this translated memory address in step 218, the read data may be returned to the processing unit of the subsystem in step 220, and the bootstrapping of this subsystem may proceed in step 224 with the boot code received in step 222. The returned subsystem boot code may also include a hard-coded interconnect address for the control interconnect, and possibly also other unique identification information. For example, unique identifiers such as internet MAC addresses may be distributed to subsystems with the returned boot code before the external network boots. This information allows to boot the control interconnect, and eventually the device is completely booted and ready for use.

While in the above a booting procedure for one subsystem of a modular system has been described, this procedure will of course be similar for any further subsystem to be booted. For each further subsystem requesting boot, steps 204 to 224 of FIG. 6 will be repeated. As shown in FIG. 4, the flash element 12 (or optionally several physically separated flash elements) may hold all necessary boot codes. The DRAM element 14 may be used for allocating boot stacks for the boot codes of GIMMU and all subsystems. Boot codes are associated to the correct subsystems by the hard-coded addresses and associations regarding subsystems and data ports in the GIMMU boot code. Each subsystem 20, 30, 40 is only able to access its own boot code identified by the data port, and access to the subsystem-specific boot code by other subsystems or from the outside is restricted.

Using such a boot procedure, components may be designed completely modular and cost-effective, since no separate non-volatile memory is required in each subsystem, and the subsystems are independent from actual boot structures, memory architectures and other higher-level implementations. A subsystem may then be able to operate in various different memory organizations. Also, legacy systems may be adapted to such a modular device by incorporating the local memory management unit 24 only, since all further access operations for retrieving the boot codes and so on are conducted by the global memory manager 10 in connection with central memory elements 12, 14.

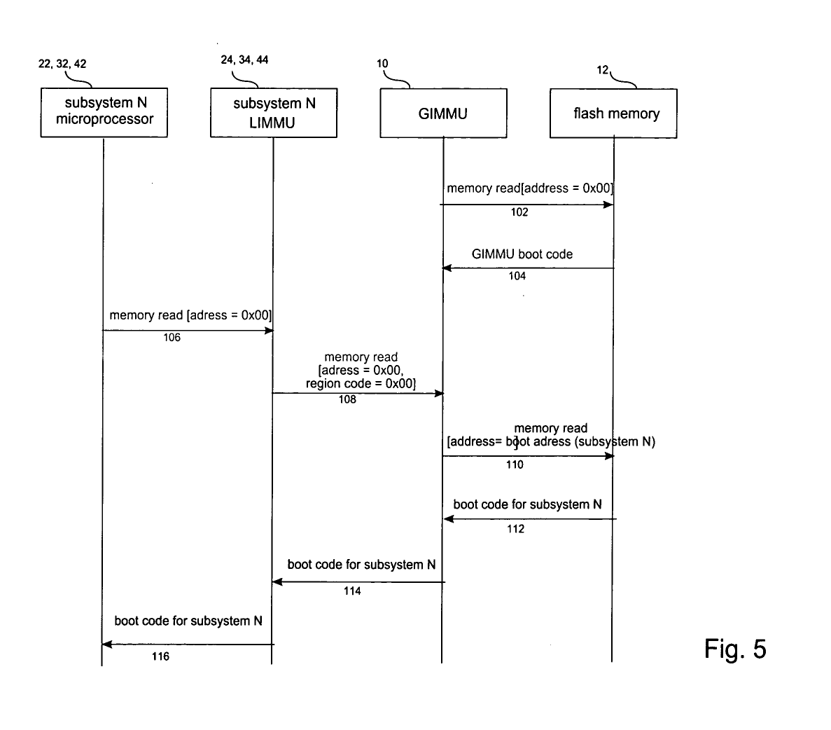

The memory accesses during a first-level (i.e. subsystem) bootstrap of a subsystem N in a modular system with several subsystems can also be seen from the communication scheme of FIG. 5. In a first step the GIMMU 10 initiates 102 a memory access to flash memory with the address 0x00. Of course, in other embodiments, another specific memory address or even another addressing scheme may be used, as long as the address is predefined such that the boot code may be retrieved. From the flash memory, the GIMMU boot code is returned 104 from this address.

Now, an arbitrary subsystem N may begin addressing 106 memory with its reset address value (e.g. 0x00), which is given from the subsystem processor to the local memory management unit LIMMU of the subsystem. LIMMU also starts up in boot mode and may convert the subsystem memory access address into a boot memory access, i.e. add a specific region code for indicating a boot access. Again, this region code may e.g. be 0x00, and the address value is transmitted 108 to the GIMMU together with the region code. From the address, region code and the data port on which these were received, the GIMMU will be able to convert this access to a flash memory access 110 with the correct address extracted from the GIMMU boot code. Subsequently, the subsystem boot code read from flash memory will backtrack 112, 114, 116 to the requesting subsystem processor.

In this exemplary boot scheme, there was no DRAM used at all. This may e.g. be done in a XIP (execute in place) architecture, which allows code to be executed from the same location at which it is permanently stored. It is also possible that the GIMMU copies the requested boot codes from flash to DRAM and then boots from DRAM.

Optionally, the global memory manager 10 may also keep track of the boot status of some or all subsystems. For example, after a boot code has been successfully transmitted to a corresponding subsystem 20, 30, 40, the GIMMU may update a parameter table, set a bit flag or store a boot success indication for this subsystem in any other way. Such an indication may for example be used to disable access to the boot code after the boot procedure is finished in order to prevent accidental or malicious accesses to the subsystem boot code.

Regarding the interconnects 15, 18 in the memory architecture, it is not necessary to have two different interconnections as in the example above. Each one might perform the functions of both interconnects. However, this can lead to performance degradation, particularly if data traffic is conveyed over the control interconnect. Also, a data interconnect may be more complex than the described point-to-point connections, as long as no software programmable configuration of the interconnect in boot is required.

Boot codes stored in a non-volatile memory element such as the flash memory of the example embodiment may be stored in an encrypted format. The code and/or key required for decrypting an encrypted boot code may permanently reside within a respective subsystem, e.g. within the memory manager LIMMU. Alternatively, only that code portion required for decrypting may be left unencrypted, and the description key may be stored in the subsystem. In order to ensure error-free data transfers between all system components during the boot procedure, error correction and detection methods such as CRC may further be used.

In further embodiments, the GIMMU may also be programmed to boot some or all of the subsystems in a specific order. For example, this may be necessary when subsystems are dependent on other subsystems, or for energy management purposes. The order to be followed in a boot procedure may e.g. be stored within the GIMMU boot code.

Another implementation is based on a memory network structure, which may be composed of routers forming a mesh topology and several memory modules connected to these routers. The memory may be organized in a way that enables performing data transfers through the memory, which therefore implicitly buffers transferred data. Memory interconnection may be based on mesh topology and a packet-switched routing scheme. As in the above examples, a global memory management unit GIMMU may be present for controlling the interconnection, and also local management units LIMMU on each module. The GIMMU may then configure the routers as well as the LIMMUs. Again, the GIMMU may keep track of allocated memory, receive and process memory allocation requests, and configure local management units. In the local management units LIMMU, tables may be present for address translation and memory protection which are configured by GIMMU.

A table may be used for translating a local memory address into a physical memory address as above. Routers route data between subsystems and memory modules. They may e.g. use store-and-forward routing, based on x and y coordinates of the destination router; wormhole routing; virtual cut-through routing; or source routing. Each router may have a unique router identifier that may be queried from the router, which typically corresponds to its x,y-coordinates. Also, a router has one or more ports for connection which are identified by unique port numbers. A LIMMU may request a router's ID and use the returned router identifier RID in a memory allocation request for routing through the network, and together with memory address and port number for use of allocated memory.

In a memory network architecture similar to the one described above, the basic bootstrap procedure may be performed as in the previous examples, but the memory element storing subsystem boot codes should of course be accessible. This may mean that the memory (e.g. the flash element) has to be accessible from a predefined pair of xy-address and port number, such as x=0, y=0, port#=0. Again, the values do not necessarily have to be zero, but may be any predefined value which allows to perform the boot procedure as described. In further implementations, the association between subsystem and corresponding boot code address at the GIMMU may be made from the pair of source x-y-address and source port number.

It will be understood that all of the above details, examples and implementations may also be combined or in part replaced by other details. Any memory organization which allows a two-level memory access scheme as explained above may implement embodiments of the invention. The physical memory address is resolved from a local address, a region code and a data port in any arbitrary way. While region codes as used in the example embodiments are generally used for allocating memory regions to subsystems, there may be some reserved region codes which cannot be altered or reassigned at run-time, which also excludes malicious changes to the system. One of these region codes may then be the predefined region code indicating a boot code access, usually given as 0x00 in the examples.

By interpreting a predefined region code (or another identifier for memory access) as a boot access, a memory manager is able to distinguish this access from normal memory accesses or allocation requests and may return the correct subsystem boot code based on the origin of the memory access. With the region code concept or another similar concept, this also retains logical modular memory setup, as each subsystem can only access and use its own memory space as controlled by the global memory manager, while at the same time the actual physical memory structure is external to all subsystems and may be developed and organized independently from the subsystem components. If for some reason further memory is arranged within a subsystem, this memory may also be completely decoupled from the central controlled memory elements. Altogether, a simple boot procedure for modular devices with component-independent memory organization is provided.

Although exemplary embodiments of the present invention have been described, these should not be construed to limit the scope of the appended claims. Those skilled in the art will understand that various modifications may be made to the described embodiments and that numerous other configurations or combinations of any of the embodiments are capable of achieving these same results. Moreover, to those skilled in the various arts, the invention itself will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention.

What is claimed is:

1. A method comprising:
retrieving a first boot code from a non-volatile memory element;
receiving a memory access request from at least one subsystem, said memory access including at least a boot status indication indicating a memory region and a memory address;
if said received address and region match a predefined address and region, associating said at least one subsystem with a corresponding subsystem boot code address included in said retrieved first boot code;
retrieving a corresponding subsystem boot code from said associated boot code address; and
transferring said boot code to said corresponding subsystem.

2. The method of claim 1, further comprising
determining a data port the memory access request has been received on, and
associating said determined data port with a subsystem boot code address based on information included in said first boot code.

3. The method of claim 2, further comprising extracting said information related to associations of data ports and subsystems and to subsystem boot code addresses from said first boot code.

4. The method of claim 1, further comprising allocating memory regions for said boot codes at a volatile memory element.

5. The method of claim 1, wherein said method is performed by a global memory management unit connected to said at least one subsystem and said memory elements.

6. The method of claim 5, wherein said connection is achieved by a point-to-point network.

7. The method of claim 1, wherein several memory access requests are received, further comprising handling said requests in a predefined order.

8. The method of claim 1, wherein said subsystem boot code includes information for booting a network coupled to said subsystem.

9. The method of claim 8, wherein said information includes a media access control MAC address.

10. The method of claim 1, further comprising, after transferring said subsystem boot code, storing an indication of said completed boot code transfer.

11. The method of claim 10, wherein said indication is a bit flag.

12. The method of claim 10, wherein said indication is stored in a parameter table and associated with a corresponding subsystem identifier.

13. The method of claim 10, further comprising if said indication corresponds to a completed boot code transfer, preventing any further access to said boot code address.

14. The method of claim 1, restricting any write accesses to said boot code addresses.

15. The method of claim 1, further comprising restricting any read accesses to a specific subsystem boot code address for all subsystems not associated with said specific subsystem boot code.

16. The method of claim 1, wherein said method is performed on power-up of a modular system.

17. A method comprising:
issuing a memory access request using a predefined address value and a boot status indication;
receiving a boot code in response to said request; and
performing a boot procedure based on said boot code.

18. The method of claim 17, said issuing further comprising:
issuing said memory access request with said predefined address value to a local memory manager; and
adding said predefined boot status indication to said request at said local memory manager.

19. The method of claim 17, further comprising setting a processor register to a reset value.

20. The method of claim 19, wherein said issuing of said memory access request is triggered by said register reset value.

21. The method of claim 17, further comprising decrypting said received boot code.

22. The method of claim 21, further comprising utilizing decryption code included in an unencrypted part of said received boot code.

23. The method of claim 22, further comprising utilizing a decryption key stored in a local non-volatile memory element.

24. The method of claim 21, further comprising utilizing decryption code stored in a local non-volatile memory element.

25. The method of claim 17, further comprising booting an external network, and transmitting said memory access request via said network.

26. The method of claim 25, wherein said steps are performed by a subsystem including at least a processor and a non-volatile memory element, wherein boot code for said external network is stored on said non-volatile memory element.

27. The method of claim 17, wherein said steps are performed by a subsystem including at least a processor, wherein said subsystem is connected to an external global memory manager.

28. A computer program product comprising computer code which, when executed on a processor or microcontroller, will execute the method steps of claim 1.

29. A computer program product comprising computer code which, when executed on a processor or microcontroller, will execute the method steps of claim 17.

30. A system comprising:
at least one subsystem including a processing unit and a local memory management unit;
a global memory management unit connected to said at least one subsystem;
a non-volatile memory element connected to said global memory management unit;
wherein boot codes for said global memory manager and said at least one subsystem are stored in said non-volatile memory element, and wherein said boot codes are located at predefined memory addresses.

31. The system of claim 30, further comprising a volatile memory element connected to said global memory management unit.

32. The system of claim 30, wherein said boot code for said global memory manager includes at least information on memory addresses for said at least one subsystem boot code.

33. The system of claim 30, wherein said global memory management unit is connected via a data interconnect.

34. The system of claim 33, wherein said data interconnect is a point-to-point connection.

35. The system of claim 30, wherein said subsystems are connected via a control interconnect.

36. The system of claim 35, wherein said control interconnect is a network having routing capabilities.

37. A system comprising:
means for retrieving a first boot code from a non-volatile storage means;
means for receiving a memory access request from at least one subsystem, said memory access including at least a boot status indication indicating a memory region and a memory address;
means for deciding whether said received address and region match a predefined address and region;
means for associating said at least one subsystem with a corresponding subsystem boot code addresses included in said retrieved first boot code;
means for retrieving a corresponding subsystem boot code from said associated boot code address; and
means for transferring said boot code to said corresponding subsystem.
